(19) United States
(12) Patent Application Publication
(10) Pub. No.: US 2026/0134875 A1
(43) Pub. Date: May 14, 2026

(54) DIRECTION CONTROL BEAMFORMING DEVICE

(71) Applicant: mpWAV Inc., Seoul (KR)

(72) Inventors: Hyung Min PARK, Seoul (KR); Byung Joon CHO, Seoul (KR)

(21) Appl. No.: 18/964,016

(22) Filed: Nov. 29, 2024

(30) Foreign Application Priority Data
Nov. 13, 2024 (KR) 10-2024-0160774

(51) Int. Cl. G10L 21/0224; G10L 21/0216; G10L 25/06

(52) U.S. Cl. CPC G10L 21/0224; G10L 25/06; G10L 2021/02166

(57) ABSTRACT

According to an embodiment, a direction control beamforming device includes a region provision unit and a beamforming unit. The region provision unit may provide an estimated region of a target sound source based on an estimated direction vector of the target sound source that is calculated from an input signal. The beamforming unit may provide an output signal by performing beamforming based on the input signal, the estimated direction vector, and the estimated region.

The direction control beamforming device According to the present disclosure may further improve performance of voice recognition by providing a beamforming output signal based on a pre-determined target region and an estimated region of a target sound source that is generated based on an estimated direction vector of the target sound source.

### CROSS-REFERENCE TO RELATED APPLICATION(S)

This application claims benefit of priority to Korean Patent Application No. 10-2024-0160774 filed on Nov. 13, 2024 in the Korean Intellectual Property Office, the disclosure of which is incorporated herein by reference in its entirety.

### BACKGROUND

### 1. Field

The present disclosure relates to a direction control beamforming device.

### 2. Description of Related Art

An input signal input through a microphone may not only include a target voice necessary for voice recognition, but also include noise that interferes with the voice recognition. In recent years, various studies have been conducted to improve performance of the voice recognition by removing noise from the input signal and extracting only the desired target voice.

### RELATED ART DOCUMENT

### Patent Document

Korean Patent No. 10-1133308 (registered on Mar. 28, 2012)

### SUMMARY

An aspect of the present disclosure may provide a direction control beamforming device for further improving performance of voice recognition by providing a beamforming output signal based on a pre-determined target region and an estimated region of a target sound source that is generated based on an estimated direction vector of the target sound source.

According to an embodiment, a direction control beamforming device includes a region provision unit and a beamforming unit. The region provision unit may provide an estimated region of a target sound source based on an estimated direction vector of the target sound source that is calculated from an input signal. The beamforming unit may provide an output signal by performing beamforming based on the input signal, the estimated direction vector, and the estimated region.

The region provision unit may include a direction vector estimation unit and an estimated region unit. The direction vector estimation unit may calculate the estimated direction vector of the target sound source from the input signal. The estimated region unit may provide the estimated region of the target sound source based on the input signal and the estimated direction vector.

The estimated region unit may calculate the estimated region based on the estimated direction vector and a relative transfer function for an external region where the input signal is capable of being received by the microphone.

The estimated region unit may include a coefficient unit and a selection unit. The coefficient unit may calculate a correlation coefficient between the estimated direction vector and the relative transfer function. The selection unit may provide a selected transfer function corresponding to relative the transfer function corresponding to a maximum correlation coefficient having a largest value among the correlation coefficients.

The estimated region unit may further include an estimation unit. The estimation unit may provide the estimated region corresponding to the selected transfer function.

The beamforming unit may include a determination unit and a plurality of beamformers. The determination unit may provide a determination result based on the selected transfer function and a target transfer function for a pre-determined target region included in the external region. The plurality of beamformers may each provide the output signal based on the determination result.

The determination unit may provide a first determination result or a second determination result based on whether the selected transfer function is included in the target transfer function.

The plurality of beamformers may include a first beamformer and a second beamformer. If the determination result provided from the determination unit is the first determination result, the first beamformer may provide a first output signal among the output signals by beamforming the input signal.

If the determination result provided from the determination unit is the second determination result, the second beamformer may provide a second output signal beamformed by removing the target sound source corresponding to the estimated direction vector from the input signal.

The device may further include a mask. The mask may be pre-determined based on an existence probability of sound included in the input signal.

In addition to the above-mentioned technical tasks of the present disclosure, other features and advantages of the present disclosure may be described below, or may be clearly understood by those skilled in the art to which the present disclosure pertains from such description and explanation.

### BRIEF DESCRIPTION OF DRAWINGS

FIG. 1 is a view showing a direction control beamforming device according to embodiments of the present disclosure.

FIG. 2 is a view for describing the direction control beamforming device shown in FIG. 1.

FIG. 3 is a view showing a region provision unit included in the direction control beamforming device in FIG. 1.

FIGS. 4 and 5 are views for describing an estimated region unit included in the direction control beamforming device in FIG. 1.

FIG. 6 is a view for describing an example of the estimated region unit included in the direction control beamforming device in FIG. 1.

FIG. 7 is a view showing a beamforming unit included in the direction control beamforming device in FIG. 1.

FIG. 8 is a view for describing a mask included in the direction control beamforming device in FIG. 1.

### DETAILED DESCRIPTION

In the specification, in adding reference numerals to components throughout the drawings, it should be noted that like reference numerals designate like components even though components are shown in different drawings.

Meanwhile, meanings of the terms described in this specification should be understood as follows.

A term of a single number may include its plural number unless explicitly indicated otherwise in the context, and a scope of the present disclosure is not limited to this term.

It should be understood that a term “include”, “have”, or the like does not preclude the presence or addition of one or more other features, numerals, operations, components, parts or combinations thereof, mentioned in the specification.

Hereinafter, embodiments of the present disclosure are described in detail with reference to the accompanying drawings.

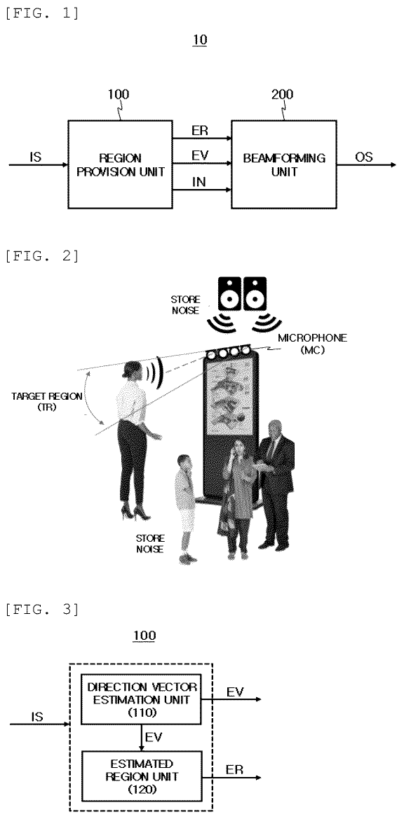

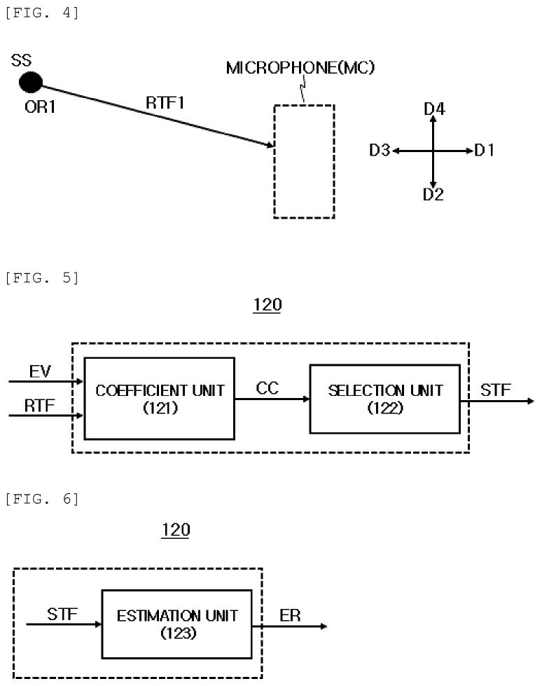

FIG. 1 is a view showing a direction control beamforming device according to embodiments of the present disclosure, FIG. 2 is a view for describing the direction control beamforming device shown in FIG. 1, and FIG. 3 is a view showing a region provision unit included in the direction control beamforming device in FIG. 1.

Referring to FIGS. 1 to 3, a direction control beamforming device 10 according to an embodiment of the present disclosure may include a region provision unit 100 and a beamforming unit 200. The region provision unit 100 may provide an estimated region ER of a target sound source based on an estimated direction vector EV of the target sound source that is calculated from an input signal IS.

In an embodiment, the region provision unit 100 may include a direction vector estimation unit 110 and an estimated region unit 120. The direction vector estimation unit 110 may calculate the estimated direction vector EV of the target sound source from the input signal IS. A method for estimating the direction vector from the input signal IS may be variously implemented. For example, the direction vector may be estimated from a target sound source angle or a delay from the target sound source to a microphone MC that is acquired using generalized cross-correlation (GCC), steered response power (SRP), or the like. Alternatively, a target sound source mask may be acquired using complex Gaussian mixture model (CGMM) or a neural network to thus calculate a target sound source covariance, and a main eigenvector of the target sound source covariance may thus be used as the direction vector. In addition, the direction vector may be estimated using a method disclosed in Korean Patent Laid-Open Publication No. 10-2021-0142268.

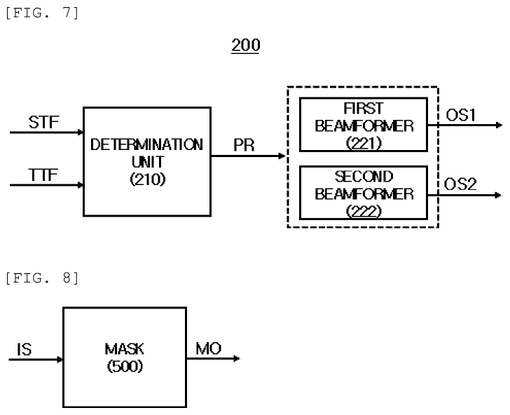

FIGS. 4 and 5 are views for describing the estimated region unit included in the direction control beamforming device in FIG. 1, and FIG. 6 is a view for describing an example of the estimated region unit included in the direction control beamforming device in FIG. 1.

Referring to FIGS. 1 to 6, the estimated region unit 120 may provide the estimated region ER of the target sound source based on the input signal IS and the estimated direction vector EV.

In an embodiment, the estimated region unit 120 may calculate the estimated region ER based on the estimated direction vector EV and a relative transfer function RTF for an external region OR where the input signal IS may be received by the microphone MC. Here, the external region OR may refer to a certain region or location near the microphone MC. For example, a first relative transfer function RTF1 may refer to a transfer function for a path through which sound is transmitted to the microphone MC from the first external region OR1 if a target sound source SS is disposed in the first external region OR1. A second relative transfer function may refer to a transfer function for a path through which the sound is transmitted to the microphone MC from a second external region OR2 different from the first external region OR1. In this way, the relative transfer function may be the transfer function for the path through which the sound is transmitted to the microphone MC from the external region OR.

For example, a set of the relative transfer functions RTFs for all regions where the input signal IS may be received by the microphone MC may be expressed as [Equation 1] below.

$${r}_{f} = \{ {r}_{1 , f} , {r}_{2 , f} , ⋯ {r}_{{N}_{θ} , f} \} . \qquad [ Equation 1 ]$$

Here, r_{f} indicates the set of the relative transfer functions, N_{θ} indicates the number of the relative transfer functions, and f indicates a frequency.

In an embodiment, the estimated region unit 120 may include a coefficient unit 121 and a selection unit 122. The coefficient unit 121 may calculate a correlation coefficient CC between the estimated direction vector EV and the relative transfer function RTF. For example, the correlation coefficient CC may be expressed as [Equation 2] below.

$${ρ}_{θ , t , f} = \frac{{r}_{θ , f}^{H} {\hat{h}}_{t , f}}{‖ {r}_{θ , f} ‖ \cdot ‖ {\hat{h}}_{t , f} ‖} , {r}_{θ , f} ∈ {r}_{f} . \qquad [ Equation 2 ]$$

Here, p_{θ,t,f} indicates the correlation coefficient, r_{θ,f} indicates the relative transfer function, and h_{t,f} indicates the estimated direction vector.

The selection unit 122 may provide a selected transfer function STF corresponding to the relative transfer function corresponding to the maximum correlation coefficient CC having the largest value among the correlation coefficients CC. For example, the selected transfer function STF may be expressed as [Equation 3] below.

$${\hat{r}}_{θ , f} = arg {max}_{{r}_{θ , f}} {ρ}_{θ , t , f} . \qquad [ Equation 3 ]$$

Here, \hat{r}_{θ,f} indicates the selected transfer function, and P_{θ,t,f} indicates the correlation coefficient.

In an embodiment, the estimated region unit 120 may further include an estimation unit 123. The estimation unit 123 may provide the estimated region ER corresponding to the selected transfer function STF. For example, if the selected transfer function STF among the plurality of relative transfer function RTFs is the first relative transfer function RTF1, the first external region OR1 corresponding to the first relative transfer function RTF1 may be provided as the estimated region ER.

FIG. 7 is a view showing the beamforming unit included in the direction control beamforming device in FIG. 1, and FIG. 8 is a view for describing the mask included in the direction control beamforming device in FIG. 1.

Referring to FIGS. 1 to 8, the beamforming unit 200 may provide an output signal OS by performing beamforming based on the input signal IS, the estimated direction vector EV, and the estimated region ER.

In an embodiment, the beamforming unit 200 may include a determination unit 210 and a plurality of beamformers. The determination unit 210 may provide a determination result PR based on the selected transfer function STF and a target transfer function for a pre-determined target region TR included in the external region. For example, as shown in FIG. 2, when a customer orders in front of a kiosk, a region where sound of the customer is generated may be predicted to some extent in advance. In this case, an operator of the direction control beamforming device 10 according to the present disclosure may set the pre-determined target regions TRs in advance, and the target regions TRs may be included in the external region OR.

In an embodiment, the determination unit 210 may provide a first determination result PR1 or a second determination result PR2 based on whether the selected transfer function STF is included in the target transfer function. The target transfer function may refer to the transfer function for the path through which the sound is transmitted to the microphone MC from the target region TR. For example, if the selected transfer function STF is included in the target transfer function, the target sound source may be within the target region TR and the direction vector of the target sound source may be correctly estimated. In this case, the determination unit 210 may provide the first determination result PR1. On the other hand, if the selected transfer function STF is not included in the target transfer function, the target sound source may be outside the target region TR, and the direction vector of the target sound source may be incorrectly estimated. In this case, the determination unit 210 may provide the second determination result PR2.

In an embodiment, the plurality of beamformers may each provide the output signal OS based on the determination result PR. In another embodiment, the plurality of beamformers may include a first beamformer 221 and a second beamformer 222. If the determination result PR provided from the determination unit 210 is the first determination result PR1, the first beamformer 221 may provide a first output signal OS1 among the output signals OS by beamforming the input signal IS. For example, if the determination unit 210 provides the first determination result PR1, the first beamformer 221 may update the direction vector of the target sound source to the estimated direction vector EV to thus provide the first output signal OS1.

For example, if the determination unit 210 provides the first determination result PR1, the direction vector may be updated as shown in [Equation 4] below.

$${h}_{t , f} ← {\hat{h}}_{t , f} . \qquad [ Equation 4 ]$$

Here, h_{t,f} indicates the direction vector, and ĥ_{t,f} indicates the estimated direction vector.

In an embodiment, if the determination result PR provided from the determination unit 210 is the second determination result PR2, the second beamformer 222 may provide a second output signal OS2 beamformed by removing the target sound source corresponding to the estimated direction vector EV from the input signal IS. For example, if the determination unit 210 provides the second determination result PR2, the second beamformer 222 may form a Null for the estimated direction vector EV to suppress the inflow of noise, and update the direction vector of the target sound source as one of the target transfer functions to thus provide the second output signal OS2.

For example, if the determination unit 210 provides the second determination result PR2, a noise source direction vector may be updated as shown in [Equation 5] below.

$${u}_{t , f} ← {\hat{h}}_{t , f} . \qquad [ Equation 5 ]$$

Here, u_{t,f} indicates the noise source direction vector, and ĥ_{t,f} indicates the estimated direction vector.

For example, if the determination unit 210 provides the second determination result PR2, the direction vector may be updated as shown in [Equation 6] below.

$${h}_{t , f} ← {\tilde{r}}_{θ , f} , {\tilde{r}}_{θ , f} ∈ {\tilde{r}}_{f} . \qquad [ Equation 6 ]$$

Here, h_{t,f} indicates the direction vector, \tilde{r}_{θ,f} indicates the target transfer function, and \tilde{r}_{f} indicates a set of the target transfer functions.

A variety of beamforming methods may be used here. For example, the beamforming may be performed using the method disclosed in Korean Patent Laid-Open Publication No. 10-2021-0142268. In an embodiment, the direction control beamforming device 10 may further include a mask 500.

The mask may be pre-determined based on an existence probability of the sound included in the input signal IS.

In an embodiment, a weight vector for the beamforming applied to the direction control beamforming device may be calculated based on an estimated time-varying variance.

For example, the estimated time-varying variance may be expressed as [Equation 7] below.

$${\hat{λ}}_{t , f} = max ( {μλ}_{t - 1 , f} + ( 1 - μ ) {\vert {\hat{Y}}_{t , f} \vert}^{2} , {ϵ}_{f} ) \qquad [ Equation 7 ]$$

$${\vert {\hat{Y}}_{t , f} \vert}^{2} = \frac{1}{2 {N}_{f} + 1} {\sum }_{r = f - {N}_{f}}^{f + {N}_{f}} {\vert {w}_{t - 1 , r}^{H} {x}_{t , r} \vert}^{2}$$

$${\vert {\hat{Y}}_{t , f} \vert}^{2} = \frac{1}{2 {N}_{f} + 1} {\sum }_{r = f - {N}_{f}}^{f + {N}_{f}} {\vert {ℳ}_{t , r} {w}_{l - 1 , r}^{H} {x}_{t , r} \vert}^{2}$$

the mask is given).

Here, \hat{λ}_{t,f} indicates the estimated time-varying variance, μ indicates a smoothing constant (a value greater than or equal to 0 and less than or equal to 1, for example, 0.2), t indicates time, f indicates the frequency, N_{f} indicates the number of adjacent frequency bins, 0 indicates a floor value (a constant close to 0, for example, 1e-6), x_{t,r} indicates input, |Ŷ_{t,f}|² indicates power of estimated output, and [symbol] _{t,r} indicates the mask.

In addition, a weighted covariance inverse matrix may be expressed as [Equation 8] below.

$${Ψ}_{t , f} = {[ {\sum }_{l = 1}^{t} {γ}^{t - l} ( \frac{{x}_{l , f} {x}_{l , f}^{H}}{{\hat{λ}}_{l , f}} ) ]}^{- 1} = \frac{1}{γ} ( {Ψ}_{l - 1 , f} - \frac{{Ψ}_{l - 1 , f} {x}_{t , f} {x}_{l , f}^{H} {Ψ}_{t - 1 , f}}{{\hat{γλ}}_{t , f} + {x}_{t , f}^{H} {Ψ}_{t - 1 , f} {x}_{t , f}} ) \qquad [ Equation 8 ]$$

Here, ψ_{t,f} indicates the weighted covariance inverse matrix, and γₜ₋₁ indicates a forgetting coefficient (a value greater than or equal to 0 and less than or equal to 1, for example, 0.99).

In addition, a weight vector for the first beamformer may be updated using the estimated direction vector as the direction vector of the target sound source, and may be expressed as [Equation 9] below.

$${w}_{t , f} = \frac{{Ψ}_{t , f} {h}_{t , f}}{{h}_{t , f}^{H} {Ψ}_{t , f} {h}_{t , f}} . \qquad [ Equation 9 ]$$

Here, w_{t,f} indicates the weight vector, and h_{t,f} indicates the direction vector.

In addition, the second beamformer may perform the beamforming to the updated direction vector of the target sound source (the center or mean direction of the target sound source region) and form the Null in the noise source direction vector. In this case, a weight vector for the second beamformer may be expressed as [Equation 10].

$${w}_{t , f} = {Ψ}_{t , f} ( {α}_{t , f} {h}_{t , f} + {β}_{t , f} {u}_{t , f} ) \qquad [ Equation 10 ]$$

$${α}_{l , f} = \frac{{U}_{t , f} - {η}_{f} {C}_{t , f}}{{H}_{l , f} {U}_{l , f} - {C}_{l , f} {C}_{t , f}^{*}}$$

$${β}_{l , f} = \frac{{η}_{f} {H}_{l , f} - {C}_{t , f}^{*}}{{H}_{l , f} {U}_{l , f} - {C}_{l , f} {C}_{t , f}^{*}}$$

$${H}_{t , f} = {h}_{t , f}^{H} {Ψ}_{t , f} {h}_{t , f}$$

$${U}_{t , f} = {u}_{t , f}^{H} {Ψ}_{t , f} {u}_{t , f}$$

$${C}_{t , f} = {h}_{t , f}^{H} {Ψ}_{t , f} {u}_{t , f}$$

$${C}_{t , f}^{*} = {u}_{t , f}^{H} {Ψ}_{t , f} {h}_{t , f} .$$

Here, w_{t,f} indicates the weight vector, h_{t,f} indicates the direction vector, α_{t,f} and β_{t,f} respectively indicate Lagrange multipliers for the direction vector of the target sound source and the noise source.

In addition, a time-varying variance may be expressed as [Equation 11] below.

$${λ}_{t , f} = max ( {μλ}_{t - 1 , f} + ( 1 - μ ) {\vert {Y}_{t , f} \vert}^{2} , {ϵ}_{f} ) \qquad [ Equation 11 ]$$

$${\vert {Y}_{t , f} \vert}^{2} = \frac{1}{2 {N}_{f} + 1} {\sum }_{r = f - {N}_{f}}^{f + {N}_{f}} {\vert {w}_{t , r}^{H} {x}_{t , r} \vert}^{2}$$

$${\vert {Y}_{t , f} \vert}^{2} = \frac{1}{2 {N}_{f} + 1} {\sum }_{r = f - {N}_{f}}^{f + {N}_{f}} {\vert {ℳ}_{l , r} {w}_{t , r}^{H} {x}_{l , r} \vert}^{2}$$

(if the mask is given).

Here, λ_{t,f} indicates the time-varying variance, N_{f} indicates the number of adjacent frequency bins, and |Y_{t,f}|² indicate power of a beamforming output signal.

In addition, the beamforming output signal may be expressed as [Equation 12] below.

$${Y}_{t , f} = {w}_{t , f}^{H} {x}_{t , f} . \qquad [ Equation 12 ]$$

Here, Y_{t,f} indicates the beamforming output signal, w_{t,f} indicates the weight vector, and x_{t,r} indicates the input.

The direction control beamforming device 10 according to the present disclosure may further improve performance of voice recognition by providing the beamforming output signal OS based on the pre-determined target region TR and the estimated region ER of the target sound source that is generated based on the estimated direction vector EV of the target sound source.

As set forth above, the present disclosure may provide the following effects.

The direction control beamforming device according to the present disclosure may further improve the performance of the voice recognition by providing the beamforming output signal based on the pre-determined target region and the estimated region of the target sound source that is generated based on the estimated direction vector of the target sound source.

In addition, other features and advantages of the present disclosure may be newly recognized through the embodiments of the present disclosure.

In addition to the above-mentioned technical tasks of the present disclosure, the other features and advantages of the present disclosure have been described above, or may be clearly understood by those skilled in the art to which the present disclosure pertains from such description and explanation.

What is claimed is:

1. A direction control beamforming device comprising:
a region provision unit for providing an estimated region of a target sound source based on an estimated direction vector of the target sound source that is calculated from an input signal; and
a beamforming unit for providing an output signal by performing beamforming based on the input signal, the estimated direction vector, and the estimated region.

2. The device of claim 1, wherein the region provision unit includes
a direction vector estimation unit for calculating the estimated direction vector of the target sound source from the input signal, and
an estimated region unit for providing the estimated region of the target sound source based on the input signal and the estimated direction vector.

3. The device of claim 2, wherein the estimated region unit calculates the estimated region based on the estimated direction vector and a relative transfer function for an external region where the input signal is capable of being received by the microphone.

4. The device of claim 3, wherein the estimated region unit includes
a coefficient unit for calculating a correlation coefficient between the estimated direction vector and the relative transfer function, and
a selection unit for providing a selected transfer function corresponding to the relative transfer function corresponding to a maximum correlation coefficient having a largest value among the correlation coefficients.

5. The device of claim 4, wherein the estimated region unit further includes an estimation unit for providing the estimated region corresponding to the selected transfer function.

6. The device of claim 5, wherein the beamforming unit includes
a determination unit for providing a determination result based on the selected transfer function and a target transfer function for a pre-determined target region included in the external region, and
a plurality of beamformers for each providing the output signal based on the determination result.

7. The device of claim 6, wherein the determination unit provides a first determination result or a second determination result based on whether the selected transfer function is included in the target transfer function.

8. The device of claim 7, wherein the plurality of beamformers include a first beamformer and a second beamformer, and
if the determination result provided from the determination unit is the first determination result, the first beamformer provides a first output signal among the output signals by beamforming the input signal.

9. The device of claim 8, wherein if the determination result provided from the determination unit is the second determination result, the second beamformer provides a second output signal beamformed by removing the target sound source corresponding to the estimated direction vector from the input signal.

10. The device of claim 9, wherein a weight vector for the beamforming applied to the direction control beamforming device is calculated based on an estimated time-varying variance.

11. The device of claim 9, further comprising a mask pre-determined based on an existence probability of sound included in the input signal.
